(19) United States
(12) Patent Application Publication
(10) Pub. No.: US 2013/0185288 A1
(43) Pub. Date: Jul. 18, 2013

(54) PRODUCT SEARCH DEVICE, PRODUCT SEARCH METHOD, AND COMPUTER PROGRAM PRODUCT

(71) Applicant: KABUSHIKI KAISHA TOSHIBA, Tokyo (JP)

(72) Inventors: Masashi NISHIYAMA, Kanagawa (JP); Shihomi Takahashi, Kanagawa (JP); Toshiaki Nakasu, Tokyo (JP); Tomoyuki Shibata, Kanagawa (JP); Kaoru Sugita, Saitama (JP); Masahiro Sekine, Tokyo (JP); Kazunori Imoto, Kanagawa (JP); Yasunobu Yamauchi, Kanagawa (JP)

(73) Assignee: KABUSHIKI KAISHA TOSHIBA, Tokyo (JP)

(21) Appl. No.: 13/741,733

(22) Filed: Jan. 15, 2013

(30) Foreign Application Priority Data
Jan. 17, 2012 (JP) 2012-007134
Dec. 7, 2012 (JP) 2012-268270

(51) Int. Cl. G06F 17/30

(52) U.S. Cl. CPC G06F 17/30554
USPC 707/722

(57) ABSTRACT

According to an embodiment, a product search device includes an obtaining unit, a determiner, a first controller, a reception unit, a retrieval unit, and a second controller. The obtaining unit obtains a first image including plural items. The determiner determines to which group each of the items in the obtained first image belongs among plural groups into which products related to the items are categorized in accordance with a predetermined categorization condition. The first controller displays the group to which each of the items belongs on a display unit. The reception unit receives a user input specifying at least one of the groups displayed on the display unit. The retrieval unit searches a storage unit storing the groups and second images of the products in an association manner, and extracts the second image corresponding to the specified group. The second controller displays the extracted second image on the display unit.

### CROSS-REFERENCE TO RELATED APPLICATION(S)

This application is based upon and claims the benefit of priority from Japanese Patent Application No. 2012-007134, filed on Jan. 17, 2012 and Japanese Patent Application No. 2012-268270, filed on Dec. 7, 2012; the entire contents of which are incorporated herein by reference.

### FIELD

Embodiments described herein relate generally to a product search device, a product search method, and a computer program product.

### BACKGROUND

A service is khown that uses an image obtained by capturing an identifier such as a barcode and a two-dimensional bar code, which are attached to various products, so as to retrieve detailed information of a product or information of another product related to this product. A technique without such identifiers is proposed in which a captured image of one product is analyzed to search for another product related to this product, so as to offer the related product.

However, if the image includes a plurality of items, this known technique has difficulty in efficiently searching for a product of interest to a user based on this image.

### BRIEF DESCRIPTION OF THE DRAWINGS

FIG. 1 is a block diagram of a product search device according to a first embodiment;

FIG. 2 is a table illustrating an example of data structure of data stored in a storage unit according to the first embodiment;

FIGS. 3A to 3C are diagrams illustrating determination method using a k-nearest neighbor algorithm according to the first embodiment;

FIG. 4 is a flowchart illustrating a procedure of a product search process according to the first embodiment;

FIG. 5 is a diagram illustrating an exemplary first image;

FIG. 6 is a diagram illustrating groups displayed on a display unit;

FIG. 7 is a diagram illustrating an example of data structure of data stored in a storage unit according to a second embodiment;

FIGS. 8A to 8C are diagrams illustrating determination method using a k-nearest neighbor algorithm according to the second embodiment;

FIGS. 9A to 9C are diagrams illustrating an exemplary image;

FIG. 10 is a diagram illustrating an example of data structure of data stored in a storage unit according to a third embodiment;

FIGS. 11A to 11C are diagrams illustrating determination method using a k-nearest neighbor algorithm according to the third embodiment;

FIGS. 12A to 12C are diagrams illustrating an exemplary image;

FIG. 13 is a block diagram illustrating a functional configuration of a search device according to a fourth embodiment;

FIG. 14 is a diagram illustrating a reception of a first position;

FIG. 15 is a flowchart illustrating a procedure of a product search process according to the fourth embodiment; and

FIG. 16 is a block diagram of a product search system according to a fifth embodiment.

### DETAILED DESCRIPTION

According to an embodiment, a product search device includes an obtaining unit, a determiner, a first controller, a reception unit, a retrieval unit, and a second controller. The obtaining unit is configured to obtain a first image including a plurality of items. The determiner is configured to determine to which group each of the items in the obtained first image belongs among a plurality of groups. The groups are groups into which products related to the items are categorized in accordance with a predetermined categorization condition. The first controller is configured to display the group to which each of the items belongs on a display unit. The reception unit configured to receive, from a user, an input that specifies at least one of the groups displayed on the display unit. The retrieval unit is configured to search a storage unit, which stores in advance the groups and second images of the products so as to be associated with each other, and extract the second image corresponding to the specified group. The second controller is configured to display the extracted second image on the display unit.

Various embodiments will be described in detail with reference to the accompanying drawings.

### First Embodiment

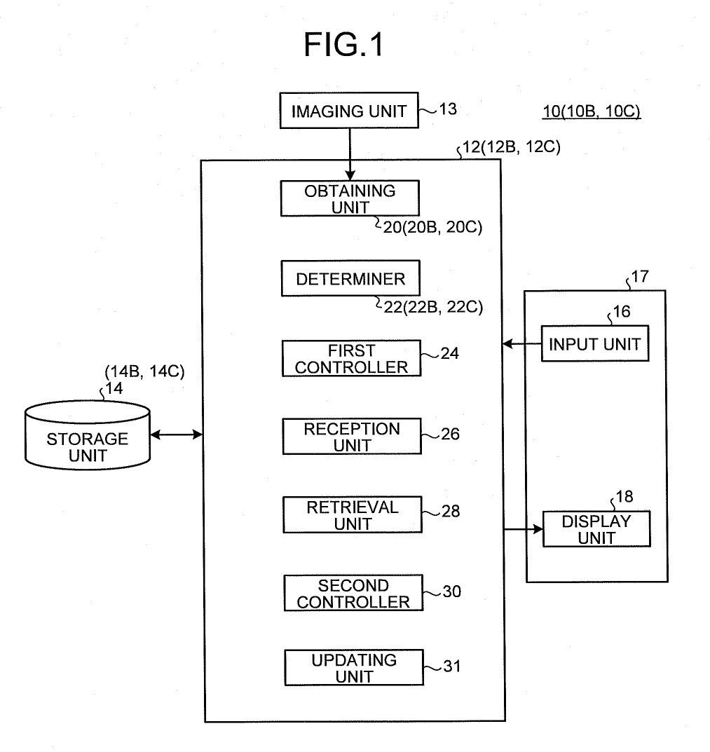

FIG. 1 is a block diagram of a functional configuration of a product search device 10 according to a first embodiment. The product search device 10 includes a controller 12, an imaging unit 13, a storage unit 14, an input unit 16, and a display unit 18.

In the first embodiment, a description will be given of an example where the product search device 10 is a portable terminal (such as a smartphone and tablet PC (personal computer)) and includes, in an integrated form, the controller 12, the imaging unit 13, the storage unit 14, the input unit 16, and the display unit 18. The product search device 10 is not limited to a portable terminal. For example, the product search device 10 may be configured such that at least one of the storage unit 14, the input unit 16, and the display unit 18 is provided separately from the controller 12. In this case, for example, a PC that has the imaging unit 13 may serves as the product search device 10.

The product search device 10 will be described in detail below.

The imaging unit 13 takes an image to obtain a first image.

The first image includes a plurality of items. Here, an item means a search target of the product search device 10. Specifically, the item means a search target product or things related to the search target product. More specifically, the item includes an item related to clothing and accessories, an item related to furniture, an item related to travel, and an item related to electrical appliances, but the item is not limited thereto.

The first image may be any image insofar as the first image includes a plurality of items. Examples of the first image includes a captured image of a subject wearing a plurality of items, a captured image in a magazine featuring a plurality of items, or a captured image displayed on a display unit. The subject is not limited to an actual person. The subject may be a pet such as a dog and a cat, a mannequin or a picture that imitates shapes of a human body and a pet, or a similar thing. The display unit employs a known LCD (Liquid Crystal Display), a CRT (Cathode Ray Tube), a PDP (Plasma Display Panel), or a similar display.

In the first embodiment, a case where the first image is an image including a plurality of items related to clothing and accessories will be described.

An item related to clothing and accessories is a search target of the product search device 10 according to the first embodiment. Specifically, the item related to clothing and accessories means a viewable search target such as a garment, which is used for dressing person and includes a thing related to beauty, a hairstyle, and similar thing. The garment means clothing or an accessory. The clothing means an item wearable by a subject. The clothing includes, for example, outerwear, skirts, trousers, shoes, a hat, and a similar item. The accessory is a craft product for dressing, such as a ring, a necklace, a pendant, and earrings. The thing related to beauty includes a hairstyle and cosmetics to be applied to skin or other parts.

The imaging unit 13 employs a known digital camera, a digital camcorder, or a similar unit. The imaging unit 13 outputs the first image, which is obtained by taking an image, to the controller 12.

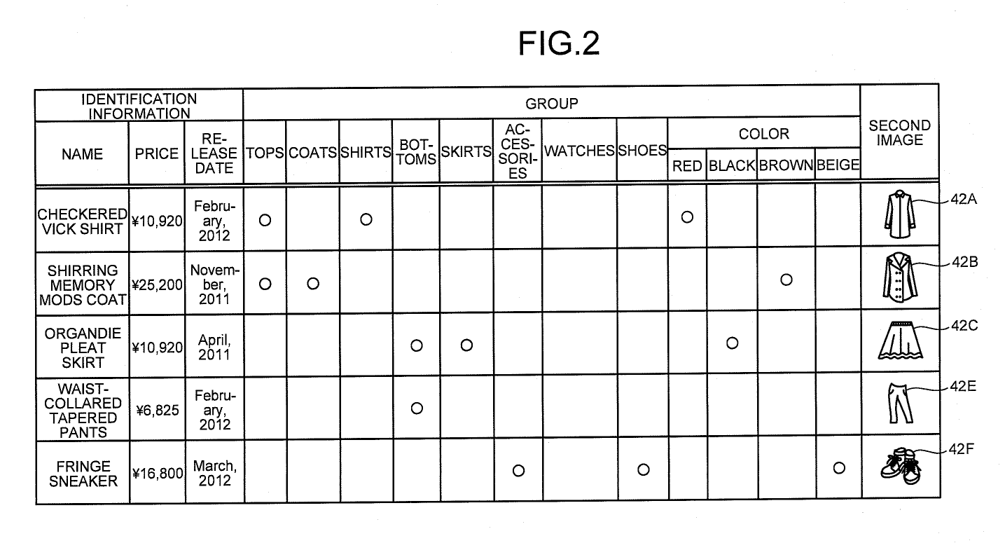

The storage unit 14 is a storage medium such as a hard disk drive (HDD). FIG. 2 is a table illustrating an example of data structure of data stored in a storage unit 14.

The storage unit 14 stores therein identification information, a group, and a second image so as to be associated with one another. The second image represents a product related to items. A product means an item to be an article of commerce. In the first embodiment, a case where the second image shows an individual product related to clothing and accessories. A product related to clothing and accessories means an item to be an article of commerce among items related to clothing and accessories. Accordingly, the second image may be an image of the individual product described above, such as a coat, a skirt, and outerwear. FIG. 2 illustrates an example where second images 42A to 42F, which are stored in advance in the storage unit 14, as the second images. The second images, which are stored in the storage unit 14, are not limited to the second images 42A to 42F. The number of the second images stored in the storage unit 14 is also not limited to a specific number.

The identification information is information to uniquely identify a product shown by the second image. FIG. 2 illustrates an example where identification information includes the name, the price, and the release date of the product shown by the corresponding second image. The identification information may be any information insofar as the information uniquely identifies a product shown by each of the second images. The identification information may be information other than a name, a price, a release date, and may include information other than the name, the price, the release date.

The products shown by the respective second images are categorized into a plurality of the groups in accordance with the predetermined categorization condition. Any conditions may be set in advance to the categorization condition. The categorization condition includes, for example, a color, a type, a manufacturer, a release date, a price range of the product. The type of the product includes a portion of body on which the product is put, a material of the product, and a shape of the product. Examples of the types of the product include a top, a coat, a shirt, bottoms, a skirt, an accessory, and a watch.

FIG. 2 illustrates an example where there are groups called Tops, Coats, Shirts, Bottoms, Skirts, Accessories, Watches, Shoes, and Colors (Red, Black, Brown, and Beige). Each group may be further categorized into a plurality of smaller groups. In FIG. 2, “√” indicates that the product shown in the corresponding second image belongs to the group indicated by a column that includes “√”. For example, FIG. 2 illustrates an example where the second image 42A belongs to the group “Tops” and “Shirts”.

In FIG. 2, a description will be given of an example where the storage unit 14 stores therein, as the groups corresponding to respective second images, information indicating whether or not each product of the second image belongs to each one of the groups. Alternativly, the storage unit 14 may store therein probability of each product of the second image belonging to each one of the groups.

The categorization condition is not necessarily limited to one condition. A plurality of categorization conditions may be set. Depending on the categorization condition, one product shown in a product image may belong to only one group, and one product shown in a product image may belong to multiple groups.

In the example illustrated in FIG. 2, for example, the product of the second image 42A belongs to the groups Tops, Shirts, and Red. The product of the second image 42B belongs to the groups Tops, Coats, and Brown. The product of the second image 42C belongs to the groups Bottoms, Skirts, and Black. The product of the second image 42E belongs to the group Bottoms. The product of the second image 42F belongs to the groups Accessories, Shoes, and Beige.

Referring back to FIG. 1, the display unit 18 displays various images, which include the first images obtained by the controller 12, the groups retrieved by the controller 12, and the second images retrieved by the controller 12 (detailed later). A known display device such as an LCD, a CRT, and a PDP may serve as the display unit 18.

The input unit 16 serves as means that allows a user to perform various input operations. The input unit 16 may include, for example, a computer mouse, buttons, a remote controller, a keyboard, a speech recognizer such as a microphone, and a similar device.

The input unit 16 and the display unit 18 may be configured in an integrated form. Specifically, the input unit 16 and the display unit 18 may be configured as a UI (User Interface) unit 17 that includes both of an input function and a displaying function. The UI unit 17 may employ an LCD with a touchscreen or a similar device.

The controller 12 is a computer that includes a CPU (Central Processing Unit), a ROM (Read Only Memory), and a RAM (Random Access Memory). The controller 12 controls the whole product search device 10. The controller 12 is electrically connected to the imaging unit 13, the storage unit 14, the input unit 16, and the display unit 18.

The controller 12 includes an obtaining unit 20, a determiner 22, a first controller 24, a reception unit 26, a retrieval unit 28, a second controller 30, and an updating unit 31.

The obtaining unit 20 obtains the first image including a plurality of items related to clothing and accessories. In the first embodiment, a case where the obtaining unit 20 obtains a first image from the imaging unit 13 will be described.

The determiner 22 determines to which group each item in the first image obtained by the obtaining unit 20 belongs.

For example, the determiner 22 employs the nearest neighbor search or the k-nearest neighbor algorithm to determine to which group each item in the first image obtained by the obtaining unit 20 belongs.

First, a description will be given of a case where the determiner 22 employs the nearest neighbor search to make the above-described determination. In this case, the determiner 22 first calculates a feature value in a candidate region corresponding to an item in the first image. The candidate region denotes a region that is included in a search window, which is used for searching. The determiner 22 also calculates a feature value of each product shown in a second image stored in the storage unit 14. The feature value of each product shown in a second image may be preliminarily calculated. The storage unit 14 may store therein the calculated feature values so as to be associated with the corresponding second images. In this case, the determiner 22 acquires the feature value of the product shown in the second image by simply reading the feature value associated with the second image stored in the storage unit 14.

The feature value of each item is a numerical value that is obtained by analyzing each of the regions corresponding to the respective items in the first image. Namely, the numerical value is a numerical value corresponding to the feature of each item or a combination of numerical values. In order to detect to which group each item in the first image belongs, the determiner 22 sets candidate regions, which are changed in size or position in the first image, so as to calculate feature values in the candidate regions.

Specifically, the determiner 22 calculates a feature value corresponding to the categorization condition for the groups stored in the storage unit 14. In the case where the color and the type of the product are used as the categorization conditions, the determiner 22, for example, quantifies colors of the candidate region in the first image (pixel values for R, G, and B), and a shape of an outline in the candidate region, so as to obtain numerical values as the feature values for each item. Namely, the determiner 22 calculates the feature values using HoG or SIFT descriptor, or a combination of HoG and SIFT descriptors, as feature values depending on the categorization condition.

A feature value of a product shown in the second image is a numerical value obtained by analyzing the second image. Namely, the numerical value is a numerical value corresponding to the feature of the product shown in the second image or a combination of numerical values. The determiner 22 analyzes the second image to obtain the feature value of the product.

The determiner 22 calculates the feature value for the second image corresponding to the same categorization condition as the first image. For example, the determiner 22 quantifies colors of the candidate region in the first image (pixel values for R, G, and B) and the shape of the outline of the candidate region in accordance with a predetermined rule, so as to obtain numerical values as the feature values for each item. In this case, the determiner 22 executes a similar operation on the second image. That is, the determiner 22 quantifies colors of the second image (pixel values for R, G, and B), and the shape of the outline of the product shown in the second image, so as to obtain numerical values as the feature values of the product shown in the second image.

Subsequently, the determiner 22 calculates a degree of similarity between the feature value for the candidate region in the first image and the feature value of the product shown in the second image stored in the storage unit 14. For example, the determiner 22 calculates the degree of similarity in such a manner as follows. Let the degree of similarity be “1” in the case where the feature values are equal to each other. In contrast, let the degree of similarity be “0” in the case where the feature values are different from each other, and the difference is equal to or more than a predetermined value. With closer feature values, the degree of similarity is calculated to be larger from “0” toward “1”.

Specifically, the determiner 22 may calculate the degree of similarity using the SSD (Sum of Squared Difference), the SAD (Sum of Absolute Difference), the normalized cross-correlation, or a similar method.

Subsequently, the determiner 22 retrieves, for each of the items included in the first image, the second images that have the degree of similarity equal to or more than the first threshold value from the storage unit 14. Then, the determiner 22 retrieves the second image that has the highest degree of similarity from the second images, which have the degree of similarity equal to or more than the first threshold value, retrieved for each of the items. The determiner 22 consequently determines the group associated to the single retrieved second image as the group to which each item belongs. The first threshold value may be set in advance to any predetermined value. In this case, the determiner 22 stores therein the first threshold value.

In the case where multiple groups are associated to the single retrieved second image, the determiner 22 may determine one or more groups among the multiple groups associated to the retrieved second image, as the group to which each item belongs.

Next, a description will be given of a case where the determiner 22 employs the k-nearest neighbor algorithm to make a determination. In the case where the k-nearest neighbor algorithm is employed, the determiner 22 calculates the feature value for a candidate region that surrounds a product and a background around the products in a first image, as well as the feature value of a product shown in a second image stored in the storage unit 14, similarly to the case where the nearest neighbor search is employed. The determiner 22 also calculates the degree of similarity using the k-nearest neighbor algorithm in a similar way to the case where the nearest neighbor search is employed.

In the case where the nearest neighbor search is employed, the determiner 22 retrieves the second images that have the degree of similarity equal to or more than the first threshold value for each of the candidate regions in the first image, from the storage unit 14. Subsequently, the determiner 22 retrieves, for each item, the second image that has the highest degree of similarity from among the second images having the degree of similarity equal to or more than the first threshold value. The determiner 22 consequently determines, as the group to which each item belongs, the group being associated with the retrieved second image.

On the other hand, in the case where the k-nearest neighbor algorithm is employed, the determiner 22 retrieves, for each of the candidate regions in the first image, k pieces of the second images in descending order of the degree of similarity to each of the items, from the storage unit 14. Here, k denotes an integer equal to or more than two. The numerical value denoted by k may be stored in advance in the determiner 22. Subsequently, the determiner 22 reads, for each of the candidate region in the first image, k pieces of the second images in descending order of the degree of similarity to each of the items. Then, the determiner 22 reads the groups corresponding to the read second images, from the storage unit 14. The determiner 22 consequently calculates, for each of the groups, the sum value by summing the numbers of the read groups, so as to generate a histogram.

Alternatively, the degree of similarity may be generated with use of the values of the histogram. Specifically, the determiner 22 multiplies, for each product belonging to each one of the groups, a value (for example, “1”), which indicates that the product belongs to the group, by the degree of similarity, so as to obtain the result of the multiplication. Subsequently, the determiner 22 may use, as a histogram, the sum value by summing the results of the multiplication with respect to all the second images that are retrieved for each of the items included in the first image by means of the k-nearest neighbor algorithm.

Then, the determiner 22 simply determines a group that has the sum value in excess of the predetermined second threshold value among groups shown by the histogram, as the group to which each item included in the first image belongs. The second threshold value may be predetermined and stored in the determiner 22.

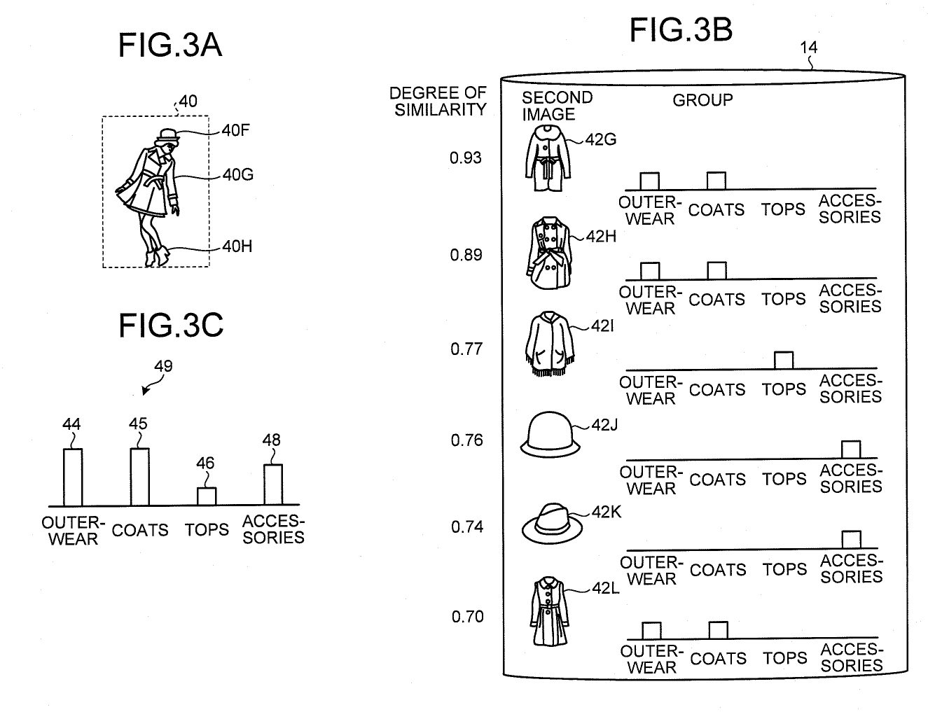

FIGS. 3A to 3C are schematic diagrams illustrating a determination method performed by the determiner 22 using the k-nearest neighbor algorithm. As illustrated in FIG. 3A, assume that a first image 40 includes an item 40F, an item 40G, and an item 40H. As illustrated in FIG. 3B, assume that the storage unit 14 stores second images 42G to 42L, the groups corresponding to the respective second images, and the identification information (not illustrated in FIG. 3B), which are associated with one another.

In this case, the determiner 22 first calculates the feature value for a candidate region that includes items 40F to 40H and a candidate region that includes a background in the first image 40, and the feature value of each of the products shown in the second images 42G to 42L stored in the storage unit 14. Subsequently, the determiner 22 calculates the degree of similarity between each candidate region and each of the second images 42G to 42L.

FIG. 3B illustrates the degree of similarity of each of the second images 42G, 42H, 42I, and 42L to the candidate region that includes the item 40G as an example. Namely, the degrees of similarities of the second images 42G, 42H, 42I, and 42L to the candidate region that includes the item 40G are 0.93, 0.89, 0.77, and 0.70, respectively. FIG. 3B also illustrates the degree of similarity of each of the second images 42J and 42K to the candidate region that includes the item 40F. Namely, the degrees of similarities of the second images 42J and 42K to the candidate region that includes the item 40F are 0.76 and 0.74, respectively. FIG. 3B illustrates only the second images that have the high degree of similarity to the candidate region.

In the example illustrated in FIG. 3B, the determiner 22 makes determination where k (described above) for the k-nearest neighbor algorithm is set to “4” for the candidate region of the item 40G included in the first image 40, while k is set to “2” for the candidate region of the item 40F included in the first image 40. However, it is preferred that the same value of k for the k-nearest neighbor algorithm, which the determiner 22 applies to each of the items in the first image 40, be set for every items included in the first image.

Subsequently, the determiner 22 reads, for each of candidate regions of the items 40F to 40H in the first image 40, k pieces of the second images in descending order of the degree of similarity to each of the items 40F to 40H. For example, the determiner 22 reads the second image 42G, the second image 42H, the second image 42I, and the second image 42L from the storage unit 14, as the second images corresponding to the candidate region of the item 40G. For example, the determiner 22 also reads the second image 42J and the second image 42K from the storage unit 14, as the second images corresponding to the candidate region of the item 40F. The determiner 22 further reads the groups corresponding to the second images (the second images 42G to 42L in the example illustrated in FIG. 3B), which have been read by candidate regions, from the storage unit 14. In the example illustrated in FIG. 3B, the determiner 22 reads “Outerwear” and “Coats” as the groups corresponding to the second image 42G. The determiner 22 also reads “Outerwear” and “Coats” as the groups corresponding to the second image 42H. The determiner 22 also reads “Tops” as the group corresponding to the second image 42I. The determiner 22 also reads “Accessories” as the group corresponding to the second image 42J. The determiner 22 also reads “Accessories” as the group corresponding to the second image 42K. The determiner 22 also reads “Outerwear” and “Coats” as the groups corresponding to the second image 42L.

Subsequently, the determiner 22 calculates, for each of the groups, the sum value by summing the number of the read groups, so as to generate a histogram. For example, as illustrated in FIG. 3C, products shown in each of the second image 42G, the, second image 42H, and the second image 42L belong to the group “Outerwear”. Accordingly, the sum value of the “Outerwear” group is “3” (see Graph 44 in FIG. 3C). Similarly, as illustrated in FIG. 3C, products shown in each of the second image 42G, the second image 42H, and the second image 42L belong to the group “Coats”. Accordingly, the sum value of the “Coats” group is “3” (see Graph 45 in FIG. 3C).

As illustrated in FIG. 3C, the product shown in the second image 42I belongs to the group “Tops”. Accordingly, the sum value of the “Tops” group is “1” (see Graph 46 in FIG. 3C). As illustrated in FIG. 3C, products shown in each of the second image 42J and the second image 42K belong to the group “Accessories”. Accordingly, the sum value of the “Accessories” group is “2” (see Graph 48 in FIG. 3C).

Subsequently, the determiner 22 determines the groups having the sum value in excess of the predetermined second threshold value among groups shown by a histogram 49 generated with the sum values, as the group to which the candidate regions of the items 40F to 40H in the first image 40 belong.

It is preferable for the determiner 22 to use the k-nearest neighbor algorithm, compared with the nearest neighbor search. The reason is described below. The determiner 22 uses the k-nearest neighbor algorithm to determine to which group each of the candidate regions in the first image belongs. This allows the determiner 22 to determine the group to which each of the candidate regions in the first image belongs more accurately than the nearest neighbor search. In the case where the nearest neighbor search is employed, the second image having the high degree of similarity to the feature value for the candidate region included in the first image, needs to be stored in the storage unit 14. On the other hand, in the case where the k-nearest neighbor algorithm is employed, a determination is made with a histogram described above. In view of this, the determiner 22 uses the k-nearest neighbor algorithm to determine the group to which each of the candidate regions in the first image belongs more accurately than the nearest neighbor search.

The determination method used by the determiner 22 is not limited to the nearest neighbor search and the k-nearest neighbor algorithm. For example, the determiner 22 may preliminarily generate a classifier to determine whether or not each item belongs to each one of the groups. In this case, the second images, which are stored in the storage unit 14, may be separated by corresponding groups, and may be used as training samples to make the classifier preliminarily learn with an SVM (Support vector machine) or Boosting. A regression analysis may be employed instead of a classifier.

Referring back to FIG. 1, the first controller 24 displays the groups to which the respective items included the first image belong, which is determined by the determiner 22, on the display unit 18.

The reception unit 26 receives various command inputs. For example, at least one of the groups displayed on the display unit 18 is selected by a user's operation command through the input unit 16. Subsequently, the reception unit 26 receives a command input to specify at least one of the groups displayed on the display unit 18.

Namely, the user is able to operate the input unit 16 while referring to the groups displayed on the display unit 18, so as to select at least one of the groups displayed on the display unit 18.

The retrieval unit 28 searches the storage unit 14 and retrieves the second images corresponding to the selected group, which is received by the reception unit 26, from the storage unit 14.

Alternatively, the retrieval unit 28 may select, from among the second images corresponding to the selected group which is received by the reception unit 26, the second images to be displayed on the display unit 18 based on the identification information associated with the second images. Then, the retrieval unit 28 may display the selected second images on the display unit 18.

In this case, the retrieval unit 28 selects the predetermined number of the second images, for example, in reverse chronological order of the release date included in the identification information, in descending order of the price included in the identification information, or in ascending order of the price included in the identification information. The identification information may include the degree of similarity determined in the determiner 22, and the retrieval unit 28 may select the predetermined number of the second images to be displayed in descending order of the degree of similarity.

The second controller 30 displays the second images retrieved by the retrieval unit 28 on the display unit 18.

The updating unit 31 updates the storage unit 14. For example, assume that a command to update the storage unit 14 is input by an operation command through the input unit 16 or a similar command, and the reception unit 26 then receives the identification information, the groups, and the second images from an external device through an I/F unit, which is not illustrated. In this case, the updating unit 31 simply stores the received identification information, the groups, and the second images in the storage unit 14 so as to update the storage unit 14.

The obtaining unit 20 receives content data through an I/F unit and a communication line, which are not illustrated. In this case, the obtaining unit 20 may be configured to further include functions to serve as a television tuner (not shown), which receives airwaves as content data from the broadcasting station, and a network interface, which receives content data from the Internet, or a similar unit.

Here, the content data is data such as a program, and metadata indicative of content of the program. The program includes a broadcast program for a TV (television), a movie or a video clip that is delivered, sold, or distributed in a storage medium such as DVD (digital versatile disk), by VOD (Video On Demand) service, or in a similar medium or service, a moving image delivered over WEB (World Wide Web), a moving image recorded by a camera or a mobile phone, and a recorded program that is recorded by a video recorder, a HDD recorder, a DVD recorder, a TV, or PC with a recording function.

The metadata is data indicative of content of programs. In the first embodiment, the metadata includes at least information indicating a product included in an image at a position (a frame) of the program, identification information of a product in the image, and a group included in the image.

In this case, the updating unit 31 extracts the second images, the identification information, and the groups from the content data. Then, the updating unit 31 stores the retrieved second images, identification information, and the groups in an association manner, so as to update the storage unit 14.

Next, the product search process performed by the product search device 10 will be described.

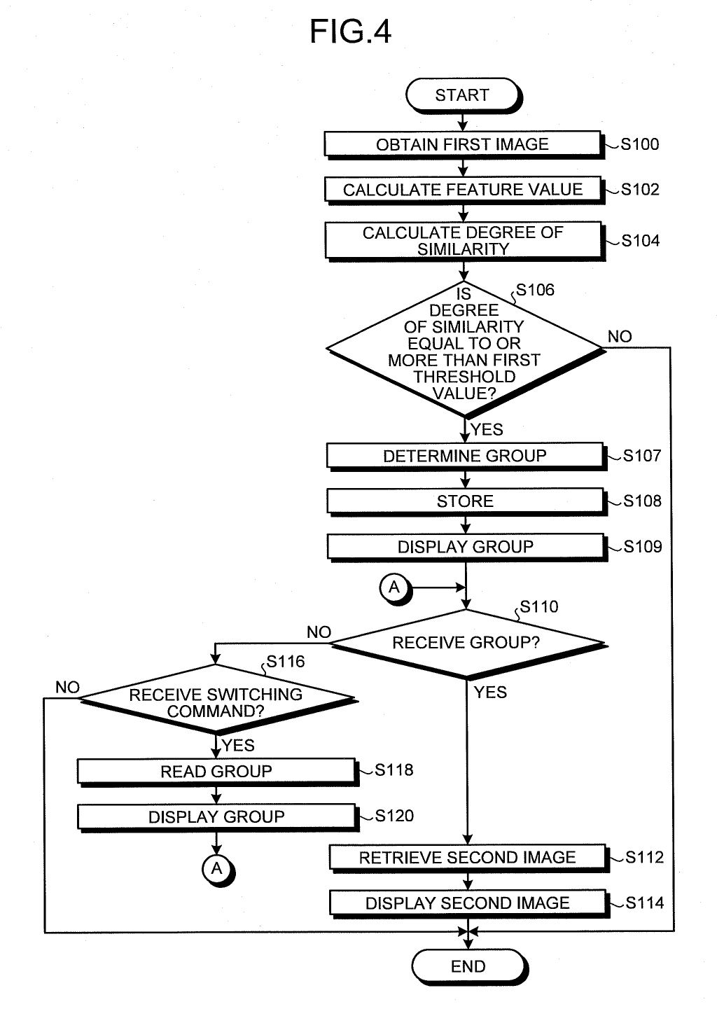

FIG. 4 is a flowchart illustrating a procedure of the product search process performed by the product search device 10 according to the first embodiment. FIG. 4 illustrates an example where the determiner 22 employs the nearest neighbor search to make a determination.

First, the obtaining unit 20 obtains a first image from the imaging unit 13 (step S100). Next, the determiner 22 calculates the feature value for each candidate region included in the first image (step S102). In the following description, it is assumed that the feature value for each product shown in each of the second images, which is stored in the storage unit 14, is calculated in advance and stored in the storage unit 14.

Next, the determiner 22 calculates the degree of similarity between the feature value for each candidate region in the first image and the feature value of the product shown in the second image stored in the storage unit 14, for each of the candidate regions (step S104).

Next, the determiner 22 determines whether all of the degrees of similarity for the respective candidate regions included in the first image, which are calculated in step S104, are equal to or more than the first threshold value (step S106). If the negative determination is made in step S106 (step S106: No), this routine will end.

On the other hand, if the positive determination is made in step S106 (step S106: Yes), the process proceeds to step S107. In step S107, the determiner 22 determines the group to which each item in the first image obtained in step S100 belongs (step S107).

Next, the determiner 22 stores the group to which each item in the first image belongs, which is determined in the process of step S107, in a RAM or a ROM (step S108). In the process of step S108, the determiner 22 may store the group in the storage unit 14.

Next, the first controller 24 displays all or at least a part of the groups stored in step S108, on the display unit 18 (step S109). After displaying the groups on the display unit 18 in step S109, the user operates the input unit 16 while referring to the groups displayed on the display unit 18. Accordingly, the user is able to select and input at least one of the groups displayed on the display unit 18.

Next, the reception unit 26 determines whether or not the group is received by the input unit 16 (step S110). If the positive determination is made in step S110 (step S110: Yes), the process proceeds to step S112.

In step S112, the second image, which corresponds to the group received in step S110, is retrieved from the storage unit 14 (step S112). Next, the second controller 30 displays the second image retrieved in step S112 on the display unit 18 (step S114), and this routine then ends.

In the case where at least one of the second images displayed in step S114 is selected by a user's operation command through the input unit 16, the second controller 30 may additionally display a website corresponding to the selected second image on the display unit 18. In this case, information indicative of a website such as a website that sells a product shown in each of the second images may be associated with the corresponding second image and stored in advance in the storage unit 14. Then, the second controller 30 may read the information indicative of the website corresponding to the selected second image from the storage unit 14, and then display the information on the display unit 18.

Additionally, the user's operation command through the input unit 16, which specifies the information indicative of the website displayed on the display unit 18, may trigger an access to the website.

On the other hand, if the negative determination is made in step S110 (step S110: No), the process proceeds to step S116.

In step S116, whether or not a switching command is received is determined (step S116). The determination in step S116 will be made with the following method. For example, when the first controller 24 displays the group on the display unit 18 as a result of the process in step S109, the first controller 24 controls additionally displaying a command button to switch the displayed group. Then, the user's operation command through the input unit 16 simply specifies the region where the command button is displayed, thus inputting the switching command. The reception unit 26 may determine whether or not the switching command is received so as to make a determination in step S116.

Alternatively, the first controller 24 may make a determination in step S116 with the following method. For example, assume that the product search device 10 is configured to include a sensor (not illustrated) that senses a tilt of the product search device 10. It is also assumed that the reception unit 26 additionally receives a signal indicative of the tilt, which is provided by the sensor. In this case, the first controller 24 may make a the positive determination in step S116 if the sensor transmits a signal, which indicates that a user who carries the product search device 10 tilts the product search device 10 at the predetermined angle, to the reception unit 26, and the reception unit 26 receives the signal.

If the negative determination is made in step S116 (step S116: No), this routine will end. On the other hand, if the positive determination is made in step S116 (step S116: Yes), the process proceeds to step S118.

In the case where the negative determination is made in step S116 (step S116: No), the reception unit 26 may determine whether or not a signal indicating that the group is not to be displayed is received. In the case where the signal indicative of such non-display of the group is received, information indicating that the group is not to be displayed on the display unit 18 may be stored in the storage unit 14. In this case, the first controller 24 simply displays the groups to be displayed on the display unit 18, among the groups determined by the determiner 22. In the case where the reception unit 26 does not receive the signal indicative of the non-display of the group, this routine simply ends.

The signal indicative of the non-display of the group may be input through the UI unit 17 to the reception unit 26, for example, when the displayed region for each of the groups displayed on the display unit 18 in the UI unit 17 is continuously pushed more than a certain period of time with a user's operation command through the input unit 16.

In step S118, the second controller 30 reads a group other than the groups displayed on the display unit 18 at the previous time, among the groups stored in step S108 (step S118). Then, the second controller 30 displays the groups, which are read in step S118, on the display unit 18 (step S120), and then the process returns to the above-described step S110.

With the product search process described above, groups to which a plurality of items included in the first image respectively belong are displayed on the display unit 18, and the second images of products corresponding to groups selected by a user, among the displayed groups, is displayed on the display unit 18.

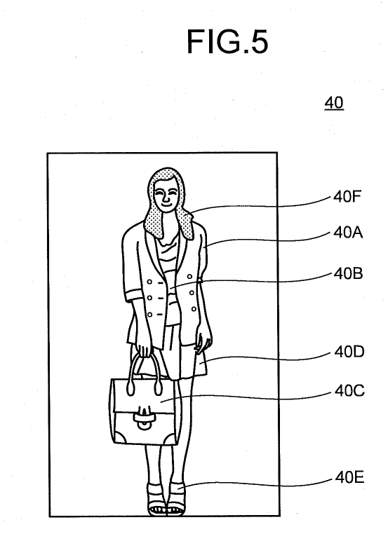

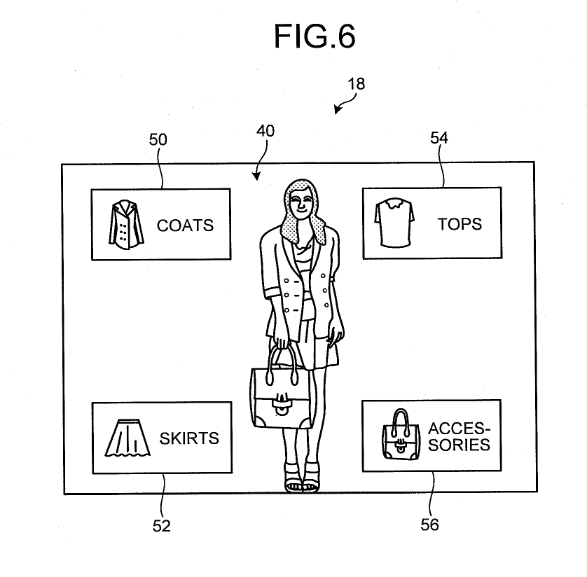

Next, a specific example of the product search process according to the first embodiment will be described. FIG. 5 is a schematic diagram illustrating an example of the first image. FIG. 6 is a schematic diagram illustrating an example of the groups displayed on the display unit 18.

As illustrated in FIG. 5, assume that the obtaining unit 20 obtains the first image 40 including items 40A to 40F as a plurality of items. In this case, the product search device 10 executes the above-described product search process, and the first controller 24 displays groups of the respective items determined by the determiner 22 on the display unit 18. As illustrated in FIG. 6, the display unit 18, for example, displays the image 54 including the characters “Tops”, which is the group to which the item 40B (see FIG. 5) belongs. The display unit 18, for example, also displays the image 50 including the characters “Coats”, which is the group to which the item 40A (see FIG. 5) belongs. The display unit 18, for example, also displays the image 56 including the characters “Accessories”, which is the group to which the item 40C (see FIG. 5) belongs. The display unit 18, for example, also displays the image 52 including the characters “Skirts”, which is the group to which the item 40D (see FIG. 5) belongs.

Here, as illustrated in FIG. 6, the first controller 24 simply displays the groups, which are determined by the determiner 22, on the display unit 18. In view of this, any display format may be employed to display the groups. For example, as illustrated in FIG. 6, the first controller 24 displays text information indicative of the groups such as “Coats”, “Tops”, “Skirts”, and “Accessories”, and the icons including the second images indicative of a typical product that belongs to the groups, so as to display the determined groups on the display unit 18. The first controller 24 may display only the text information indicative of the groups on the display unit 18, and may display only the second images indicating a typical product that belongs to the group on the display unit 18.

As illustrated in FIG. 6, it is preferred that the first controller 24 displays the images (the image 50 to the image 56) indicating the respective groups, which are superimposed onto the first image 40 obtained by the obtaining unit 20. The images (the image 50 to the image 56) indicative of the respective groups may be displayed at the four corners, at the center, or any positions on the display screen of the display unit 18. The images (the image 50 to the image 56) indicative of the respective groups may be arranged in a row toward a certain direction, and may be arranged in descending order of the values indicated in the histogram generated by the determiner 22.

The first controller 24 may display the groups, which are determined by the determiner 22, on the display unit 18 in a predetermined order of the groups on the display screen of the display unit 18. In this case, the displaying order may be specified in a user's operation command through the input unit 16, which is received at the reception unit 26, and stored in advance in the storage unit (not shown) in the first controller 24.

The first controller 24 may determine in advance the groups to be displayed on the display unit 18 and the groups not to be displayed on the display unit 18, among a plurality of groups stored in the storage unit 14 and then store those determinations. Then, the first controller 24 may display the groups, which is determined in advance to be displayed on the display unit 18, on the display unit 18, among groups determined by the determiner 22.

As described above, the product search device 10 according to the first embodiment determines the group to which each item in the first image belongs, based on the first image that includes a plurality of items related to clothing and accessories, and then displays the determined group on the display unit 18. Subsequently, the product search device 10 retrieves, from the storage unit 14, the second image of a product corresponding to the group selected by a user's operation command, among the group displayed on the display unit 18, and then displays the second image on the display unit 18.

Accordingly, the product search device 10 according to the first embodiment allows the user to efficiently search for a product of interest to the user.

The determiner 22 divides the first image into a plurality of candidate regions and performs the nearest neighbor classification, so as to determine the group to which each of a plurality of items included in the first image belongs. In view of this, the groups of the items included in the first image are accurately determined, even if the first image is an image that is captured in a state where a plurality of items overlaps with one another.

In the first embodiment, the case where the obtaining unit 20 obtains the first image from the imaging unit 13 is described. However, a method of obtaining the first image by the obtaining unit 20 is not limited to the configuration where the obtaining unit 20 obtains the first image from the imaging unit 13.

For example, the obtaining unit 20 may obtain the first image from an external device through an I/F unit (not shown interface unit) or a communication line such as the Internet. The external device includes a known PC and Web server. The obtaining unit 20 may store in advance the first image in the storage unit 14, an RAM (not shown), or a similar medium, and obtain the first image from the storage unit 14, the RAM, or the similar medium.

Alternatively, the obtaining unit 20 may obtain the first image with the following method. Specifically, first, it is assumed that the obtaining unit 20 is configured to further include the functions to serve as a television tuner (not shown) to receive airwaves as content data from the broadcasting station, a network interface to receive content data from the Internet, or a similar unit. The content data is described above, and will not be further elaborated here.

Subsequently, the controller 12 displays a program, which is included in the content data, on the display unit 18. Then, a user's operation command from the input unit 16 instructs to retrieve images. That is, the user is able to operate the input unit 16 while referring to the program displayed on the display unit 18, so as to input the command to retrieve an image, from the program displayed on the display unit 18.

The obtaining unit 20 may obtain a still picture (which may be referred to as a frame) being displayed on the display unit 18 when the obtaining unit 20 receives the command to retrieve the image, from the input unit 16, as a first image. Alternatively, the obtaining unit 20 may obtain a still picture that was displayed on the display unit 18 earlier (for example, a few seconds earlier) than the time of the reception of the command to retrieve the image, as a first image.

In the first embodiment, a description is given of the case where the second controller 30 displays the first image of the product, which is retrieved by the retrieval unit 28, on the display unit 18. However, the second controller 30 may display a fourth image, which was generated by combining the first image of the product retrieved by the retrieval unit 28 and a third image, which is an image of a subject, on the display unit 18.

The third image of a subject may be taken by the imaging unit 13 and may be obtained by the obtaining unit 20. The obtaining unit 20 may obtain the third image of a subject through a communication line. Alternatively the obtaining unit 20 may obtain the third image of a subject from the storage unit 14. In this case, the storage unit 14 may store in advance the third image of a subject.

Subsequently, the second controller 30 may generate the fourth image by combining the third image of a subject, which is obtained by the obtaining unit 20, and the first image of the product, which is retrieved by the retrieval unit 28. A known method may be employed to generate the fourth image. For example, the methods described in Japanese Unexamined Patent Application Publication No. 2011-48461 or Japanese Unexamined Patent Application Publication No. 2006-249618 may be employed to generate the fourth image.

### Second Embodiment

In the first embodiment described above, the case where the first image is an image including a plurality of items related to clothing and accessories is described. In a second embodiment, a description will be given an example where the first image is an image including a plurality of items related to furniture. A case where the second image shows an individual product related to furniture.

An item related to furniture means a search target of a product search device 10B according to the second embodiment (see FIG. 1) including furniture such as a table, a chair, a shelf, and a sofa, and things related to these furniture items, and also a viewable search target.

FIG. 1 shows a block diagram of a functional configuration of the product search device 10B according to the second embodiment. The product search device 10B includes a controller 12B, the imaging unit 13, a storage unit 14B, the input unit 16, and the display unit 18. The imaging unit 13 is similarly configured to the imaging unit 13 according to the first embodiment except that the first image including the item related to furniture is obtained through imaging. The input unit 16 and the display unit 18 are similar to those in the first embodiment.

Similarly to the product search device 10 according to the first embodiment, a description will be given of an example where the product search device 10B is a portable terminal and includes, in an integrated form, the controller 12B, the imaging unit 13, the storage unit 14B, the input unit 16, and the display unit 18. The product search device 10B is not limited to a portable terminal, and may be a PC that has the imaging unit 13.

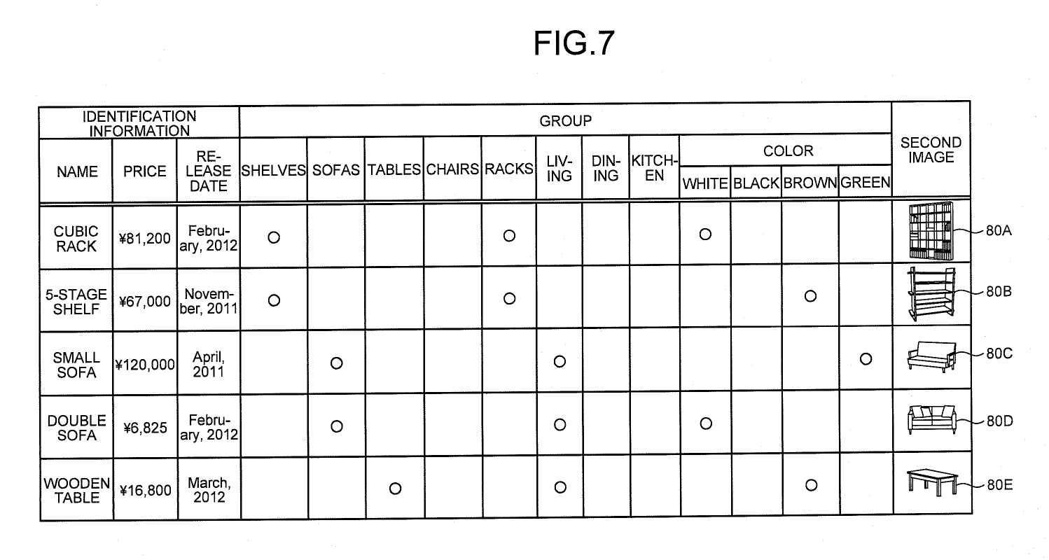

The storage unit 14B is a storage medium such as a hard disk drive. FIG. 7 is a diagram illustrating an example of data structure of data stored in the storage unit 14B.

The storage unit 14B stores therein identification information, a group, and a second image so as to be associated with one another. In the second embodiment, the second image is an image representing an individual product related to furniture. A product related to furniture means an item to be an article of commerce among items related to furniture. Accordingly, the second image may be an image of the individual product described above, such as a shelf, a sofa, and a table.

FIG. 7 illustrates an example a case where second images 80A to 80E are stored in advance in the storage unit 14B, as the second images. The second images, which are stored in the storage unit 14B, are not limited to the second images 80A to 80E. The number of the second images stored in the storage unit 14B is also not limited to a specific number.

The definitions of the identification information and the group are similar to those in the first embodiment. In the example illustrated in FIG. 7, identification information includes the name, the price, and the release date of the product shown by the corresponding second image. A description will be given of the example illustrated in FIG. 7 where the categorization condition for the groups further includes a setting place of the product.

In the example illustrated in FIG. 7, the type of the product, which is one of the categorization conditions for the groups, includes shelves, sofas, tables, chairs, and racks. In the example illustrated in FIG. 7, the setting place, which is one of the categorization conditions for the groups, includes a living room, a dining room, and a kitchen. The color of the product, which is one of the categolization conditions, includes white, black, brown, and green.

In FIG. 7, “√” indicates that the product shown in the corresponding second image belongs to the group indicated by a column that includes “√”.

For example, in the example illustrated in FIG. 7, the second image 80A belongs to the groups “Shelves”, “Racks”, and “White”. The product of the second image 80B belongs to the groups “Shelves”, “Racks”, and “Brown”. The product of the second image 80C belongs to the groups “Sofas”, “Living”, and “Green”. The product of the second image 80D belongs to the groups “Sofas”, “Living”, and “White”. The product of the second image 80E belongs to the groups “Tables”, “Living”, and “Brown”.

Referring back to FIG. 1, the controller 12B is a computer that includes the CPU, the ROM, and the RAM. The controller 12B controls the whole product search device 10B. The controller 12B is electrically connected to the imaging unit 13, the storage unit 14B, the input unit 16, and the display unit 18.

The controller 12B includes an obtaining unit 20B, a determiner 22B, the first controller 24, the reception unit 26, the retrieval unit 28, the second controller 30, and the updating unit 31. The first controller 24, the reception unit 26, the retrieval unit 28, the second controller 30, and the updating unit 31 are similar to those in the first embodiment.

The obtaining unit 20B obtains the first image including a plurality of items related to furniture. In the second embodiment, a case where the obtaining unit 20B obtains the first image from the imaging unit 13 will be described.

The determiner 22B determines to which group each item in the first image obtained by the obtaining unit 20B belongs.

For example, the determiner 22B employs the nearest neighbor search or the k-nearest neighbor algorithm to determine to which group each item in the first image obtained by the obtaining unit 20B belongs. A method of calculating the degree of similarity using the nearest neighbor search to make the determiner 22B perform the determination according to the degree of similarity is similar to that performed in the first embodiment except that the search target is the second image stored in the storage unit 14B. Similarly, a method of generating a histogram using the k-nearest neighbor algorithm to make the determiner 22B perform the determination using the histogram is similar to that performed in the first embodiment except that the search target is the second image stored in the storage unit 14B.

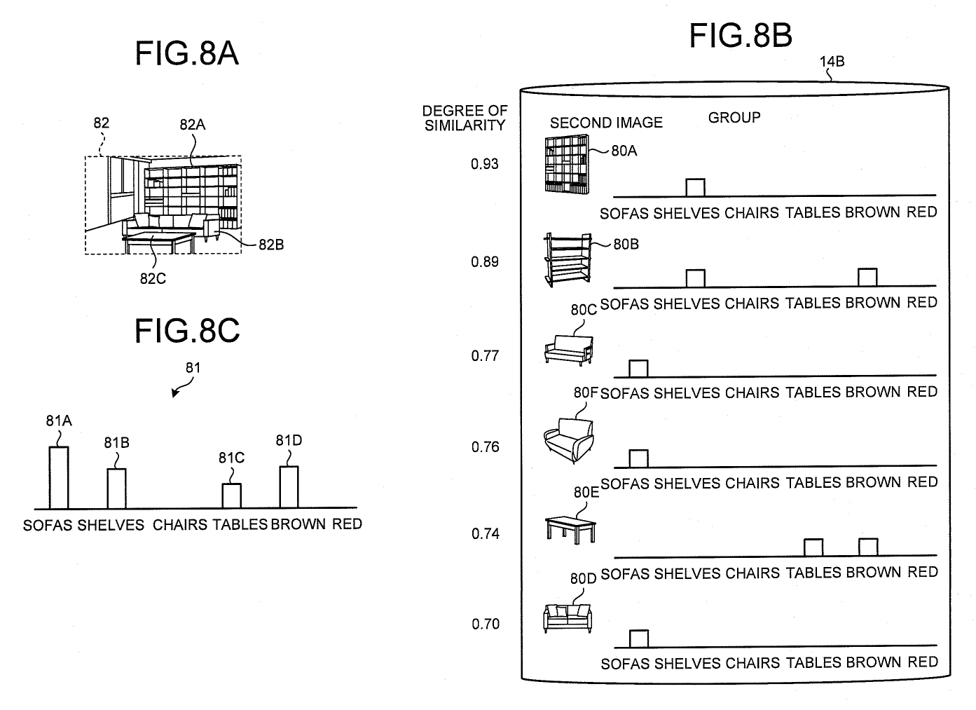

FIGS. 8A to 8C are schematic diagrams illustrating a determination method performed by the determiner 22B using the k-nearest neighbor algorithm. As illustrated in FIG. 8A, assume that a first image 82 is an image including an item 82A, an item 82B, and an item 82C. As illustrated in FIG. 8B, assume that the storage unit 14B stores second images 80A to 80F, the groups corresponding to the respective second images, and the identification information (not illustrated in FIG. 8B), which are associated with one another.

In this case, the determiner 22B first calculates the feature value for a candidate region that includes the items 82A to 82C and a candidate region that includes a background in the first image 82, and the feature value of each of the products shown in the second images 80A to 80F stored in the storage unit 14B. Subsequently, the determiner 22B calculates the degree of similarity between each candidate region and each of the second images 80A to 80F.

FIG. 8B illustrates the degree of similarity of each of the second images 80A and 80B to the candidate region that includes the item 82A as an example. Namely, the degrees of similarities of the second images 80A and 80B to the candidate region that includes the item 82A are 0.93 and 0.89, respectively.

FIG. 8B illustrates the degree of similarity of each of the second images 80C, 80F, and 80D to the candidate region that includes the item 82B. Namely, the degrees of similarities of the second images 80C, 80F, and 80D to the candidate region that includes the item 82B are 0.77, 0.76, and 0.70, respectively. FIG. 8B illustrates the degree of similarity of the second image 80E to the candidate region that includes the item 82C. Namely, FIG. 8B illustrates that the degree of similarity of the second image 80E to the candidate region that includes the item 82C is 0.74.

In FIGS. 8A to 8C, the determiner 22B makes determination where k (described above) for the k-nearest neighbor algorithm is set to “2” for the candidate region of the item 82A included in the first image 82, k (described above) is set to “3” for the candidate region of the item 82B, and k (described above) is set to “1” for the candidate region of the item 82C. However, it is preferred that the same value of k for the k-nearest neighbor algorithm, which the determiner 22B applies to each of the item in the first image 82, be set for every item included in the first image.

Subsequently, the determiner 22B reads, for each of the candidate regions of the items 82A to 82C in the first image 82, k pieces of the second images in descending order of the degree of similarity of each of the items 82A to 82C. For example, the determiner 22B reads the second images 80A and 80B from the storage unit 14B, as the second images corresponding to the candidate region of the item 82A. For example, the determiner 22B reads the second images 80C, 80F, and 80D from the storage unit 14B, as the second image corresponding to the candidate region of the item 82B. The determiner 22B further reads the second image 80E from the storage unit 14B, as the second image corresponding to the candidate region of the item 82C.

The determiner 22B further reads the groups corresponding to the second images (the second images 80A to 8OF in the example illustrated in FIGS. 8A to 8C), which have been read by candidate regions, from the storage unit 14B. The determiner 22B reads the groups corresponding to the second images 80A to 80F, which have been read by candidate regions, from the storage unit 14B. In the example illustrated in FIGS. 8A to 8C, the determiner 22B reads “Shelves” as the group corresponding to the second image 80A. The determiner 22B also reads the groups corresponding to the second images 80B to 80F.

Subsequently, the determiner 22B calculates, for each of the groups, the sum value by summing the number of the read groups, so as to generate a histogram. For example, as illustrated in FIG. 8C, the products shown in each of the second image 80C, the second image 80F, and the second image 80D belong to the group “Sofas”. Accordingly, the sum value of the “Sofas” group is “3” (see Graph 81A in FIG. 8C). Similarly, as illustrated in FIG. 8C, the products shown in each of the second image 80A and the second image 80B belong to the group “Shelves”. Accordingly, the sum value of the “Shelves” group is “2” (see Graph 81B in FIG. 8C).

As illustrated in FIG. 8C, the product shown in the second image 80E belongs to the group “Tables”. Accordingly, the sum value of the “Tables” group is “1” (see Graph 81C in FIG. 8C). As illustrated in FIG. 8C, the products shown in each of the second image 80B and the second image 80E belong to the group “Brown”. Accordingly, the sum value of the “Brown” group is “2” (see Graph 81D in FIG. 8C).

Subsequently, the determiner 22B determines the groups having the sum value in excess of a predetermined second threshold value among groups shown by a histogram 81 generated with the sum values, as the group to which the candidate regions of the items 82A to 82C in the first image 82 belong.

Similarly to the first embodiment, the determination method used by the determiner 22B is not limited to the nearest neighbor search and the k-nearest neighbor algorithm.

Referring back to FIG. 1, similarly to the first embodiment, the first controller 24 displays the groups to which the respective items included in the first image belong, which is determined by the determiner 22B, on the display unit 18.

The controller 12B of the product search device 10B according to the second embodiment performs the product search process similar to that of the first embodiment except that the second image used for the determination of the determiner 22B is the second image stored in the storage unit 14B and the first image is an image including a plurality of items related to furniture.

In the second embodiment, the controller 12B performs the product search process to display the group to which each of the plurality of items included in the first image belongs on the display unit 18. The second image of the product corresponding to the group selected by a user in the displayed group is also displayed on the display unit 18.

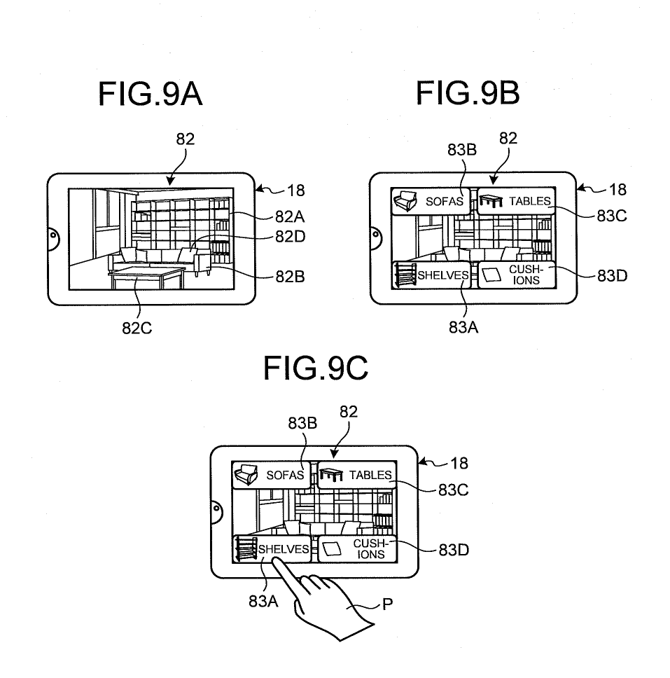

Next, a specific example of the product search process according to the second embodiment will be described. FIGS. 9A to 9C are schematic diagrams illustrating an example of the images displayed on the display unit 18.

FIG. 9A is a schematic diagram illustrating an example of the first image 82. FIGS. 9B and 9C are schematic diagrams illustrating an example of the groups displayed on the display unit 18.

As illustrated in FIG. 9A, assume that the obtaining unit 20B obtains the first image 82 including items 82A to 82D as a plurality of items. In this case, the product search device 10B executes the above-described product search process, and the first controller 24 displays groups of the respective items determined by the determiner 22B on the display unit 18.

As illustrated in FIG. 9B, the display unit 18, for example, displays the image 83A which is determined by the determiner 22B and includes the characters “Shelves”, which is the group to which the item 82A (see FIG. 9A) belongs. The display unit 18, for example, also displays the image 83B which is determined by the determiner 22B and includes the characters “Sofas”, which is the group to which the item 82B (see FIG. 9A) belongs. The display unit 18, for example, also displays the image 83C which is determined by the determiner 22B and includes the characters “Tables”, which is the group to which the item 82C (see FIG. 9A) belongs. The display unit 18, for example, also displays the image 83D which is determined by the determiner 22B and includes the characters “Cushions”, which is the group to which the item 82D (see FIG. 9A) belongs.

As illustrated in FIG. 9B, the first controller 24 only needs to display the groups, which are determined by the determiner 22B, on the display unit 18. In view of this, any display format may be employed to display the groups.

As illustrated in FIG. 9C, it is assumed that any one of the displayed groups is selected by an operation command of a user P through the input unit 16 in a state where the groups determined by the determiner 22B are displayed on the display unit 18.

In this case, the reception unit 26 receives a command input for at least one of the groups displayed on the display unit 18. The retrieval unit 28 searches the storage unit 14B and retrieves the second image corresponding to the selected group, which is received by the reception unit 26, from the storage unit 14B. The second controller 30 displays the second images retrieved by the retrieval unit 28 on the display unit 18.

As described above, the product search device 10B according to the second embodiment determines the group to which each item in the first image belongs, based on the first image that includes a plurality of items related to furniture, and then displays the determined group on the display unit 18. Subsequently, the product search device 10B retrieves, from the storage unit 14B, the first image of a product corresponding to the group selected by a user's operation command, among the groups displayed on the display unit 18, and then displays the first image on the display unit 18.

Accordingly, the product search device 10B according to the second embodiment allows the user to more efficiently search for a product of interest to the user.

### Third Embodiment

In the first embodiment described above, the case where the first image is an image including a plurality of items related to clothing and accessories is described. In a third embodiment, a description will be given an example where the first image is an image including a plurality of items related to travel, and the second image shows an individual product related to travel.

An item related to travel means a search target of a product search device 10C according to the embodiment (see FIG. 1), which includes a search target related to travel.

The item related to travel, for example, includes information with which the travel destination is geographically identifiable, information with which the travel destination is topologically identifiable, buildings in the travel destination, and seasons suitable for traveling the destination.

The information with which the travel destination is geographically identifiable includes, for example, America, Europe, Asia, Island Chain, and Africa. The information with which the travel destination is topologically identifiable includes, for example, beaches, and mountains. The buildings in the travel destination include, for example, hotels. The seasons suitable for traveling the destination includes, for example, spring, summer, fall, and winter.

FIG. 1 shows a block diagram of a functional configuration of the product search device 10C according to the third embodiment. The product search device 10C includes a controller 12C, the imaging unit 13, a storage unit 14C, the input unit 16, and the display unit 18. The imaging unit 13 is similarly configured to the imaging unit 13 according to the first embodiment except that the first image including the item related to travel is obtained through imaging. The input unit 16 and the display unit 18 are similar to those in the first embodiment.

Similarly to the product search device 10 according to the first embodiment, a description will be given of an example where the product search device 10C is a portable terminal and includes, in an integrated form, the controller 12C, the imaging unit 13, the storage unit 14C, the input unit 16, and the display unit 18. The product search device 10C is not limited to a portable terminal, and may be a PC that has the imaging unit 13.

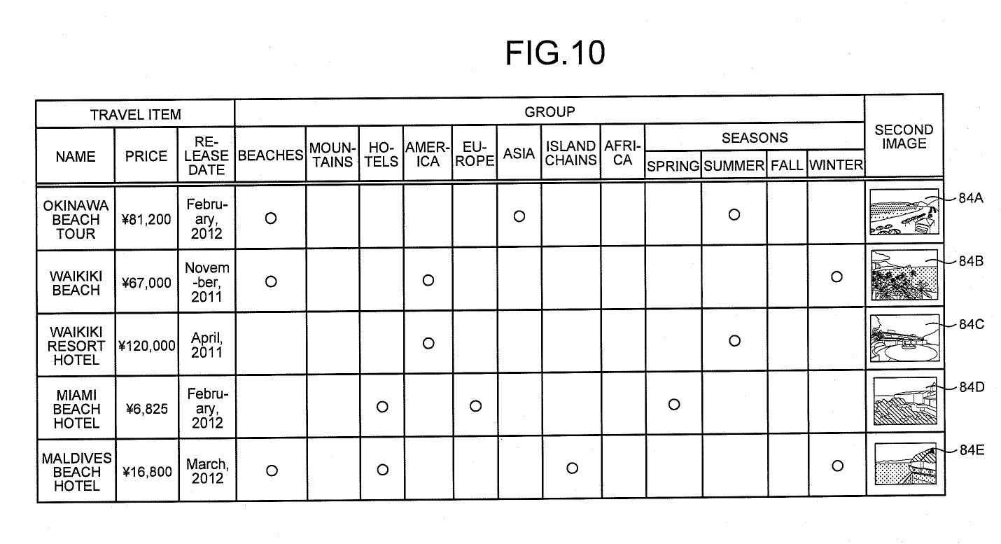

The storage unit 14C is a storage medium such as a hard disk drive. FIG. 10 is a diagram illustrating an example of data structure of data stored in the storage unit 14C.

The storage unit 14C stores therein identification information, a group, and a second image so as to be associated with one another. In the third embodiment, the second image is an image representing an individual product related to travel. In the third embodiment, a description will be given of an example where the second image is an image representing a landscape of the individual travel destination.

FIG. 10 illustrates an example a case where second images 84A to 84E are stored in advance in the storage unit 14C, as the second images. The second images, which are stored in the storage unit 14C, are not limited to the second images 84A to 84E. The number of the second images stored in the storage unit 14C is also not limited to a specific number.

The definitions of the identification information and the group are similar to those in the first embodiment. In the example illustrated in FIG. 10, identification information includes the name, the price, and the release date of the product shown by the corresponding second image. A description will be given of the example illustrated in FIG. 10 where the categorization condition for the groups includes information with which the travel destination is geographically identifiable, information with which the travel destination is topologically identifiable, buildings in the travel destination, and seasons suitable for traveling the destination.

In FIG. 10, “√” indicates that the product shown in the corresponding second image belongs to the group indicated by a column that includes “√”.

For example, in the example illustrated in FIG. 10, the second image 84A belongs to the groups “Beaches”, “Asia”, and “Summer”. The product of the second image 84B belongs to the groups “Beaches”, “America”, and “Winter”. The product of the second image 84C belongs to the groups “America” and “Summer”. The product of the second image 84D belongs to the groups “Hotels”, “Europe”, and “Spring”. The product of the second image 84E belongs to the groups “Beaches”, “Hotels”, “Island Chains”, and “Winter”.

Referring back to FIG. 1, the controller 12C is a computer that includes the CPU, the ROM, and the RAM. The controller 12C controls the whole product search device 10C. The controller 12C is electrically connected to the imaging unit 13, the storage unit 14C, the input unit 16, and the display unit 18.

The controller 12C includes an obtaining unit 20C, a determiner 22C, a first controller 24, a reception unit 26, a retrieval unit 28, a second controller 30, and an updating unit 31. The first controller 24, the reception unit 26, the retrieval unit 28, the second controller 30, and the updating unit 31 are similar to those in the first embodiment.

The obtaining unit 20C obtains the first image including a plurality of items related to travel. In the third embodiment, a case where the obtaining unit 20C obtains the first image from the imaging unit 13 will be described.

The determiner 22C determines to which group each item in the first image obtained by the obtaining unit 20C belongs.

For example, the determiner 22C employs the nearest neighbor search or the k-nearest neighbor algorithm to determine to which group each item in the first image obtained by the obtaining unit 20C belongs. A method of calculating the degree of similarity using the nearest neighbor search to make the determiner 22C perform the determination according to the degree of similarity is similar to that performed in the first embodiment except that the search target is the second image stored in the storage unit 14C. Similarly, a method of generating a histogram using the k-nearest neighbor algorithm to make the determiner 22C perform the determination using the histogram is similar to that performed in the first embodiment except that the search target is the second image stored in the storage unit 14C.

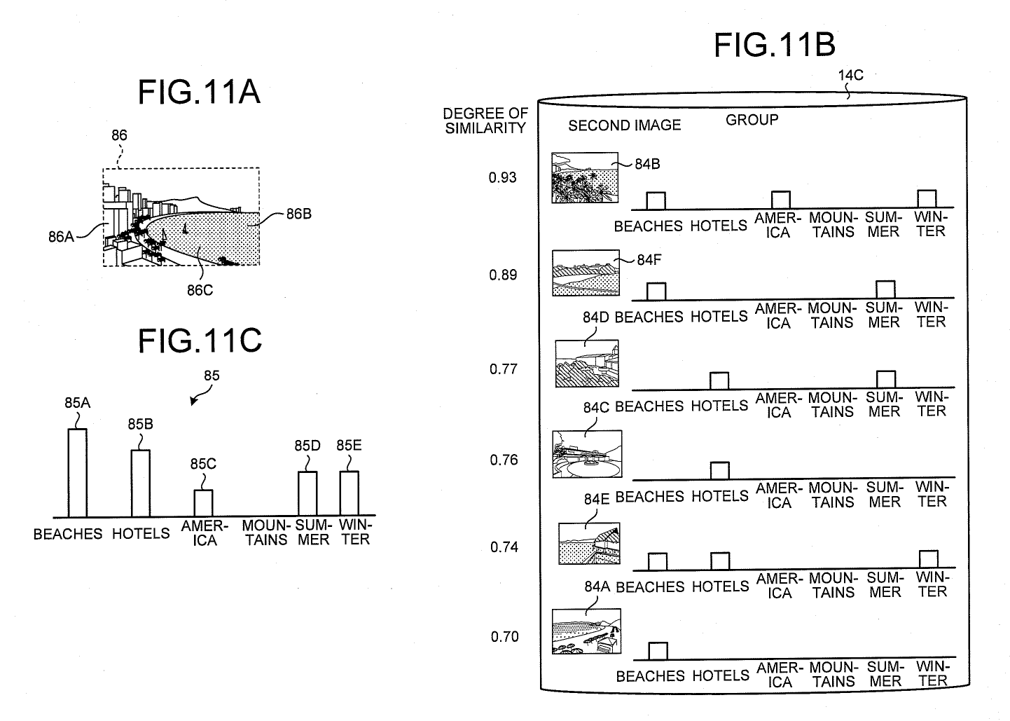

FIGS. 11A to 11C are schematic diagrams illustrating a determination method performed by the determiner 22C using the k-nearest neighbor algorithm. As illustrated in FIG. 11A, assume that a first image 86 is an image including an item 86A, an item 86B, and an item 86C.

In the following description, it is assumed that the item 86A belongs to the group “Hotels”, which represents a building in the travel destination. It is assumed that the item 86B belongs to the group “Beaches”, which is information with which the travel destination is topologically identifiable. It is assumed that the item 86C belongs to the group “America”, which is information with which the travel destination is geographically identifiable.

As illustrated in FIG. 11B, assume that the storage unit 14C stores second images 84A to 84F, the groups corresponding to the respective second images, and the identification information (not illustrated in FIG. 11B), which are associated with one another.

In this case, the determiner 22C first calculates the feature value for a candidate region that includes items 86A to 86C and a candidate region that includes a background in the first image 86, and the feature value of each of the products shown in the second images 84A to 84F stored in the storage unit 14C. Subsequently, similarly to the first embodiment, the determiner 22C calculates the degree of similarity between each candidate region and each of the second images 84A to 84F.

FIG. 11B illustrates the degree of similarity of each of the second images 84A to 84F to the candidate region that includes the items 86A to 86C as an example.

Subsequently, similarly to the first embodiment, the determiner 22C reads, for each of the candidate regions of the items 86A to 86C in the first image 86, k pieces of the second images in descending order of the degree of similarity of each of the items 86A to 86C.

The determiner 22C further reads the groups corresponding to the second images (the second images 84A to 84F in the example illustrated in FIG. 11C), which have been read by candidate regions, from the storage unit 14C. The determiner 22C reads the groups corresponding to the second images 84A to 84F, which have been read by candidate regions, from the storage unit 14C. The operation of the determiner 22C for reading the groups is similar to that in the first embodiment.

Subsequently, the determiner 22C calculates, for each of the groups, the sum value by summing the number of the read groups, so as to generate a histogram. For example, as illustrated in FIG. 11C, products shown in each of the second image 84B, the second image 84F, the second image 84E, and the second image 84A belong to the group “Beaches”. Accordingly, the sum value of the group is “34” (see Graph 85A in FIG. 11C). Similarly, as illustrated in FIG. 11C, products shown in each of the second image 84D, the second image 84C, and the second image 84E belong to the group “Hotels”. Accordingly, the sum value of the group is “3” (see Graph 85B in FIG. 11C).

As illustrated in FIG. 11C, the product shown in the second image 84B belongs to the group “America”. Accordingly, the sum value of the “America” group is “1” (see Graph 85C in FIG. 11C). As illustrated in FIG. 11C, the products shown in each of the second image 84F and the second image 84D belong to the group “Summer”. Accordingly, the sum value of the “Summer” group is “2” (see Graph 85D in FIG. 11C). As illustrated in FIG. 11C, the products shown in each of the second image 84B and the second image 84E belong to the group “Winter”. Accordingly, the sum value of the “Winter” group is “2” (see 85E in FIG. 11C).

Subsequently, the determiner 22C determines the groups having the sum value in excess of a predetermined second threshold value among groups shown by a histogram 85 generated with the sum values, as the group to which the candidate regions of the items 86A to 860 in the first image 82 belong.

Similarly to the first embodiment, the determination method used by the determiner 22C is not limited to the nearest neighbor search and the k-nearest neighbor algorithm.

Referring back to FIG. 1, similarly to the first embodiment, the first controller 24 displays the groups to which the respective items included in the first image belong, which is determined by the determiner 22C, on the display unit 18.

The controller 12C of the product search device 10C according to the third embodiment performs the product search process similar to that of the first embodiment except that the second image used for the determination of the determiner 22C is the second image stored in the storage unit 14C and the first image is an image including a plurality of items related to travel.

In the second embodiment, the controller 12C performs the product search process to display the group to which each of the plurality of items included in the first image belongs on the display unit 18. The second image of the product corresponding to the group selected by a user in the displayed group is also displayed on the display unit 18.

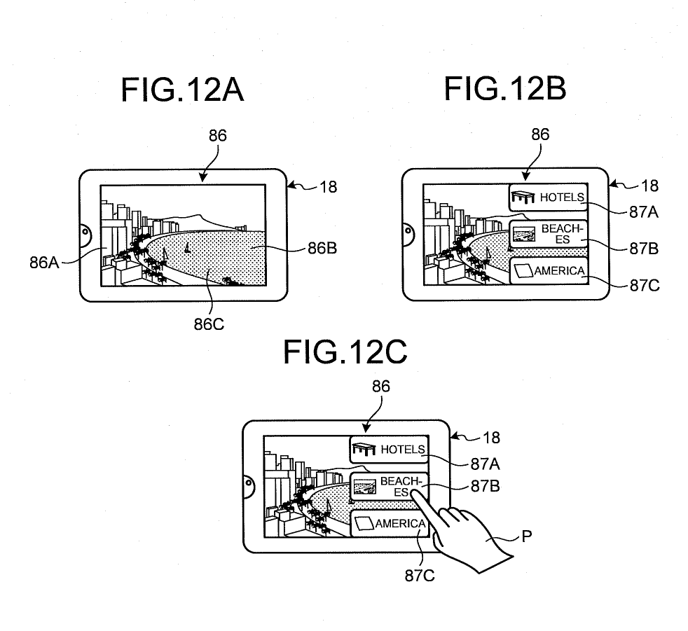

Next, a specific example of the product search process according to the third embodiment will be described. FIGS. 12A to 12C are schematic diagrams illustrating an example of the images displayed on the display unit 18.

FIG. 12A is a schematic diagram illustrating an example of the first image 86. FIGS. 12B and 12C are schematic diagrams illustrating an example of the groups displayed on the display unit 18.

As illustrated in FIG. 12A, assume that the obtaining unit 20C obtains the first image 86 including items 86A to 86C as a plurality of items. In this case, the product search device 10C executes the above-described product search process, and the first controller 24 displays groups of the respective items determined by the determiner 22C on the display unit 18.

As illustrated in FIG. 12B, the display unit 18, for example, displays the image 87A which is determined by the determiner 22C and includes the characters “Hotels”, which is the group to which the item 86A (see FIG. 12A) belongs. The display unit 18, for example, also displays the image 87B which is determined by the determiner 22C and includes the characters “Beaches”, which is the group to which the item 86B (see FIG. 11A) belongs. The display unit 18, for example, also displays the image 87C which is determined by the determiner 22C and includes the characters “America”, which is the group to which the item 86C (see FIG. 11A) belongs.

As illustrated in FIG. 11B, the first controller 24 only needs to display the groups, which are determined by the determiner 22C, on the display unit 18. In view of this, any display format may be employed to display the groups.

As illustrated in FIG. 11B, it is assumed that any one of the displayed groups is selected by an operation command of a user P through the input unit 16 in a state where the groups determined by the determiner 22C are displayed on the display unit 18 (see FIG. 11C).

In this case, the reception unit 26 receives a command input for at least one of the groups displayed on the display unit 18. The retrieval unit 28 searches the storage unit 14C and retrieves the second image corresponding to the selected group, which is received by the reception unit 26, from the storage unit 14C. The second controller 30 displays the second images retrieved by the retrieval unit 28 on the display unit 18.

As described above, the product search device 10C according to the third embodiment determines the group to which each item in the first image belongs, based on the first image that includes a plurality of items related to travel, and then displays the determined group on the display unit 18. Subsequently, the product search device 10C retrieves, from the storage unit 14C, the first image of a product corresponding to the group selected by a user's operation command, among the groups displayed on the display unit 18, and then displays the first image on the display unit 18.

Accordingly, the product search device 10C according to the third embodiment allows the user to more efficiently search for a product of interest to the user.

The product search processes according to the first embodiment to the third embodiment may be performed in a single product search device. In this case, the data stored in the storage unit 14, the storage unit 14B, and the storage unit 14C of the first embodiment to the third embodiment may be stored in the same storage unit 14 to make the determiner 22 perform the processes of the determiner 22, the determiner 22B, and the determiner 22C.

### Fourth Embodiment

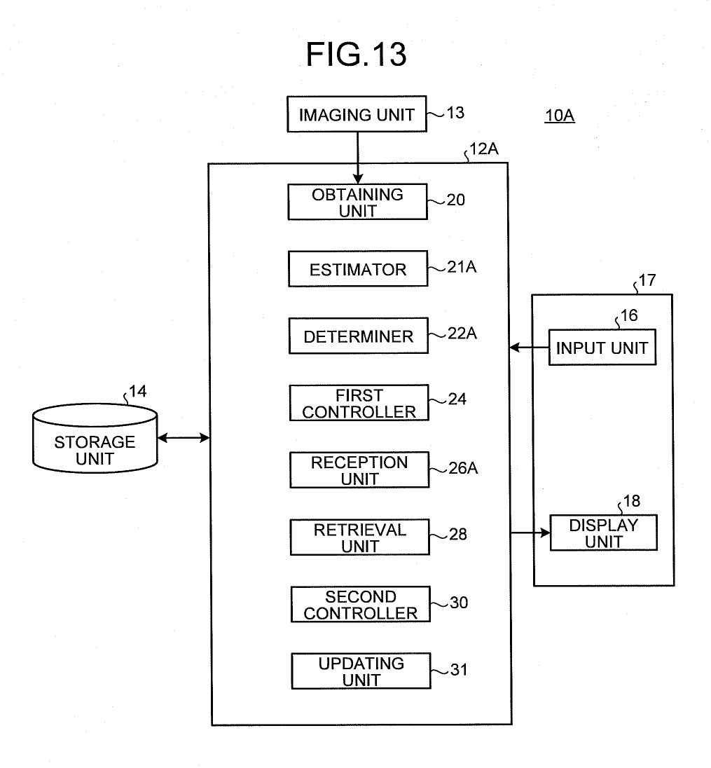

FIG. 13 is a block diagram illustrating a functional configuration of a product search device 10A according to a fourth embodiment. The product search device 10A includes a controller 12A, an imaging unit 13, a storage unit 14, an input unit 16, and a display unit 18. The input unit 16 and the display unit 18 are integrally configured as a UI unit 17.

The controller 12A is a computer that is configured to include a CPU, a ROM, and a RAM. The controller 12A controls the whole product search device 10A. The controller 12A is electrically connected to the imaging unit 13, the storage unit 14, the input unit 16, and the display unit 18. The controller 12A includes an obtaining unit 20, an estimator 21A, a determiner 22A, a first controller 24, a reception unit 26A, a retrieval unit 28, a second controller 30, and an updating unit 31.

In the fourth embodiment, functional parts identical to those of the product search device 10 according to the first embodiment are designated by the same reference numerals, and such functional parts will not be further elaborated here. The product search device 10A differs from the product search device 10 according to the first embodiment in that the product search device 10A includes the controller 12A instead of the controller 12 of the product search device 10 (see FIG. 1). The controller 12A includes the determiner 22A and the reception unit 26A instead of the determiner 22 and the reception unit 26, which are included in the controller 12 in the first embodiment (see FIG. 1). The controller 12A further includes an estimator 21A.

The reception unit 26A receives various command inputs. Similarly to the first embodiment, with a user's operation command through the input unit 16, at least one of the groups displayed on the display unit 18 is selected. Subsequently, the reception unit 26A receives a command input to specify at least one of the groups displayed on the display unit 18.

The reception unit 26A receives a first position of a target to be determined by the determiner 22, in the first image, which is obtained by the obtaining unit 20. The first position, for example, is expressed by two-dimensional coordinates in the first image.

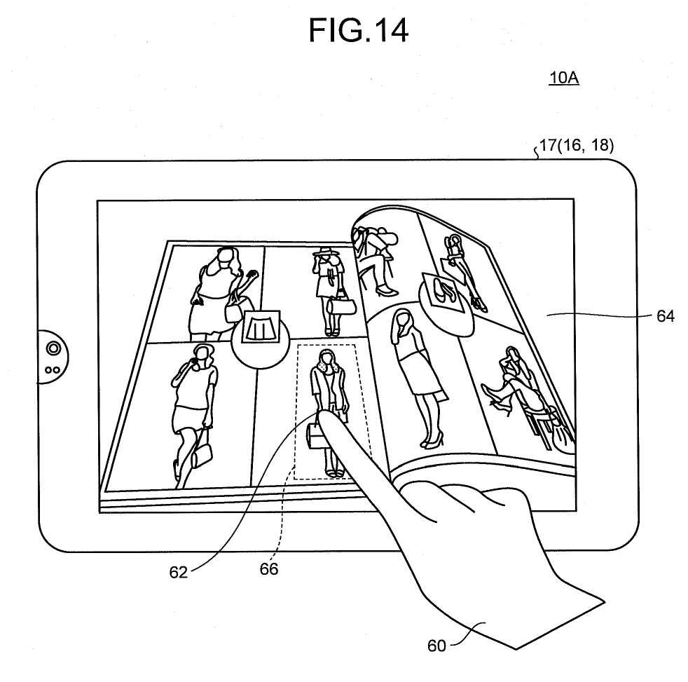

FIG. 14 is a schematic diagram illustrating a reception of the first position. For example, the first controller 24 displays the first image obtained by the obtaining unit 20 on the display unit 18 in the UI unit 17. The user operates the input unit 16 to specify any position in the first image displayed on the display unit 18 as the first position, while referring the first image displayed on the display unit 18. For example, a position 62 in a first image 64, which is displayed on the display unit 18 in the UI unit 17, is specified with a finger of a user 60. Consequently, the reception unit 26 receives the first position indicative of the specified position 62 through the input unit 16 in the UI unit 17.

The user may specify the first position by operations with fingers such as tracing, touching, pinching in, and pinching out on a touchscreen as the UI unit 17. Then, the reception unit 26A may receive an input of the first position specified through the UI unit 17.

Referring back to FIG. 13, the estimator 21A estimates a determination target region to be determined by the determiner 22A in the first image, based on the first position received by the reception unit 26A in the first image.

For example, as illustrated in FIG. 14, when the user specifies the position 62 on the first image 64 as the first position, the estimator 21A estimates a region 66 including the position 62 (the first position) as the determination target region.

An estimation by the estimator 21A may be made with a known detection method or a combination of multiple known detection methods such as human-detection, face-detection, item-detection, and a saliency map. Specifically, the estimator 21A may retrieve the first position and the peripheral region around the first position in the first image with a known detection method or a combination of multiple known detection methods described above. Then, in the case where human beings, faces, items, or the like are detected, the estimator 21A may estimate the detected region, which includes the first position, as the determination target region.

The determiner 22A determines a group to which each item included in the determination target region, which is estimated by the estimator 21A, in the first image obtained by the obtaining unit 20 belongs. The determiner 22A makes a determination similarly to the determiner 22 according to the first embodiment except that the determination target region in the first image is used to determine the corresponding item.

Next, the product search process to execute by the product search device 10A will be described.

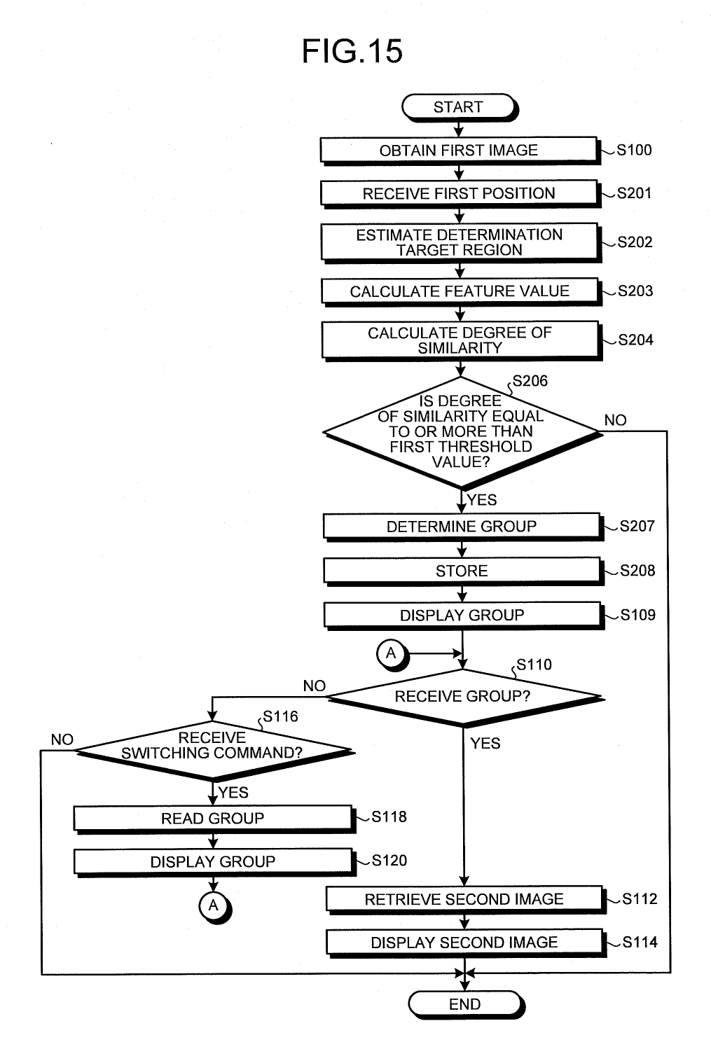

FIG. 15 is a flowchart illustrating a procedure of the product search process performed by the product search device 10A according to the fourth embodiment. Processes identical to those in the product search process according to the first embodiment, which are illustrated in FIG. 4, are designated by the same process numbers, and such processes will not be further elaborated here.

As illustrated in FIG. 15, the obtaining unit 20 first obtains a first image from the imaging unit 13 (step S100). Next, the reception unit 26A receives a first position (step S201).

Next, the estimator 21A estimates a determination target region in the first image, which is received in step S100, based on the first position, which is received in step S201 (step S202).

Next, the determiner 22A calculates the feature value for each candidate region in the determination target region in the first image (step S203). Next, the determiner 22A calculates the degree of similarity between the feature value for each candidate region in the determination target region and the feature value of the product shown in the second image stored in the storage unit 14, for each of the items (step S204).

Next, the determiner 22A determines whether all of the degrees of similarity for the respective candidate regions in the determination target region, which are calculated in step S204, are equal to or more than the first threshold value described above (step S206). If the negative determination is made in step S206 (step S206: No), this routine will end.

On the other hand, if the positive determination is made in step S206 (step S206: Yes), the process proceeds to step S207.

In step S207, the determiner 22A determines the group of each item included in the determination target region (step S207). Next, the determiner 22A stores the group to which the product in each candidate region in the determination target region in the first image, which is determined in the process of step S207, belongs, in a RAM or a ROM (step S208). In the process of step S208, the determiner 22A may store the group in the storage unit 14.

Next, the first controller 24 displays a list of all or at least a part of the groups, which are stored in step S208, on the display unit 18 (step S109). Next, the reception unit 26A determines whether or not the group is received from the input unit 16 (step S110). If the positive determination is made in step S110 (step S110: Yes), the process proceeds to step S112.

In step S112, the second image corresponding to the group, which is received in step S110, is retrieved from the storage unit 14 (step S112). Next, the second controller 30 displays the second image, which is retrieved in step S112, on the display unit 18 (step S114), and this routine will end.

On the other hand, if the negative determination is made in step S110 (step S110: No), the process proceeds to step S116. In step S116, whether or not the switching command is received is determined (step S116). If the negative determination is made in step S116 (step S116: No), this routine will end. On the other hand, if the positive determination is made in step S116 (step S116: Yes), the process proceeds to step S118.

In step S118, the second controller 30 reads a group other than the groups displayed on the display unit 18 at the previous time, among the groups stored in step S108 (step S118). Then, the second controller 30 displays the groups read in step S118 on the display unit 18 (step S120), and the process returns to the above-described step S110.

With the above-described product search process, a group to which each of a plurality of items included in the determination target region in the first image belongs is displayed on the display unit 18, and the second image of a product corresponding to a group selected by a user, among the displayed group, is displayed on the display unit 18.

As described above, the product search device 10A according to the fourth embodiment retrieves the second images of the products from the groups to which the candidate regions in the determination target region belong, based on the determination target region, which is estimated based on the first position specified by the user in the first image. Accordingly, the product search device 10A according to the second embodiment allows the user to more efficiently search for a product of interest to the user.

In the fourth embodiment, the case where the product search device 10A includes the storage unit 14 of the product search device 10 according to the first embodiment is described. The product search device 10A may include the storage unit 14B described in the second embodiment, the storage unit 14C described in the third embodiment instead of the storage unit 14. In addition, the data stored in the storage unit 14, the storage unit 14B, and the storage unit 14C may be stored in the storage unit 14.

With such configurations, the product search device 10A allows the user to more efficiently search a product of interest to the user, that is, a product related to furniture, a product related to travel, as well as a product related to clothing and accessories.

### Fifth Embodiment

In the first embodiment through the fourth embodiment described above, the case where the storage units 14, 14B, and 14C are disposed in the product search devices 10, 10A, 10B, and 10C, respectively, is described. In a fifth embodiment, a description will be given of the case where the storage units 14, 14B, and 14C are disposed in a storage unit that is connected to the product search device 10, 10A, 10B, or 10C through a communication line.

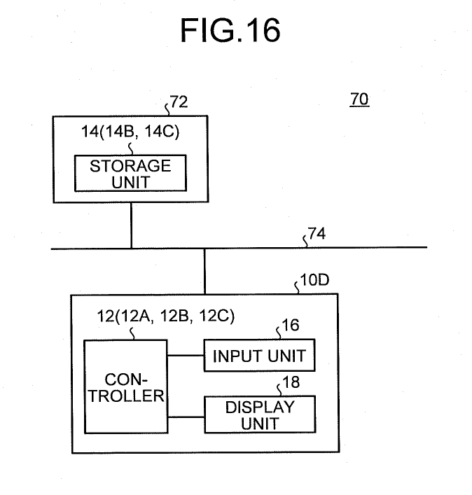

FIG. 16 is a schematic diagram illustrating a product search system 70. The product search system 70 is connected to a product search device 10D and a storage unit 72 through a communication line 74.

The product search device 10D is configured similarly to the product search device 10 in the first embodiment, the product search device 10B in the second embodiment, the product search device 10C in the third embodiment, and the product search device 10A in the fourth embodiment, except that the storage unit 14 (the storage unit 14B and the storage unit 14C) is not included. That is, the product search device 10D includes the controller 12 (the controller 12A, the controller 12B, and the controller 12C), the input unit 16, and the display unit 18. Functional parts identical to those of the first embodiment through the fourth embodiment are designated by the same reference numerals, and such functional parts will not be further elaborated here.

The communication line 74 includes a wired communication line and a wireless communication line. The storage unit 72 is a unit including the storage unit 14, and may employ a known PC, various servers, or a similar device.

As illustrated in FIG. 16, the storage unit 14 (the storage unit 14B and the storage unit 14C) is configured separately from the product search device 10D and disposed in the storage unit 72, which is connected through the communication line 74. This configuration allows a plurality of the product search device 10D to access the common storage unit 14 (the storage unit 14B and the storage unit 14C). Accordingly, this system allows a uniform management of data stored in the storage unit 14 (the storage unit 14B and the storage unit 14C).

A program that executes the above-described product search process on the product search device 10, the product search device 10A, the product search device 10B, the product search device 10C, and the product search device 10D according to the first embodiment through the fifth embodiment is preliminarily embedded in a ROM or a similar storage to provide.

The program that executes the above-described product search process on the product search device 10, the product search device 10A, the product search device 10B, the product search device 10C, and the product search device 10D according to the first embodiment through the fifth embodiment may be provided in an installable file format or an executable file format, which is recorded on a recording medium from which computers are able to read the program. The recording medium includes a CD-ROM, a flexible disk (FD), a CD-R, and a DVD (Digital Versatile Disk).

The program that executes the above-described product search process on the product search device 10, the product search device 10A, the product search device 10B, the product search device 10C, and the product search device 10D according to the first embodiment through the fifth embodiment may also be stored in a computer that is connected to a network such as the Internet so as to be provided as a downloadable file over the network. Alternatively, the program that executes the above-described product search process on the product search device 10, the product search device 10A, the product search device 10B, the product search device 10C, and the product search device 10D according to the first embodiment through the fifth embodiment may be provided or distributed through a network such as the Internet.

The program that executes the above-described product search process on the product search device 10, the product search device 10A, the product search device 10B, the product search device 10C, and the product search device 10D according to the first embodiment through the fifth embodiment is modularly configured including respective units (the obtaining unit 20, the obtaining unit 20B, the obtaining unit 20C, the determiner 22, the determiner 22B, the determiner 22C, the first controller 24, the reception unit 26, the retrieval unit 28, the second controller 30, the updating unit 31, the estimator 21A, the determiner 22A, and the reception unit 26A) described above. The hardware is operated as follows. A CPU (a processor) reads the program from the storage medium such as ROM and then executes the program to run the product search process described above. Then each of the above-described respective units are loaded on a main storage unit and generated on the main storage unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product search device, comprising:
an obtaining unit configured to obtain a first image including a plurality of items;
a determiner configured to determine to which group each of the items in the obtained first image belongs among a plurality of groups, the groups being groups into which products related to the items are categorized in accordance with a predetermined categorization condition;
a first controller configured to display the group to which each of the items belongs on a display unit;
a reception unit configured to receive, from a user, an input that specifies at least one of the groups displayed on the display unit;
a retrieval unit configured to search a storage unit, which stores in advance the groups and second images of the products so as to be associated with each other, and extract the second image corresponding to the specified group; and
a second controller configured to display the extracted second image on the display unit.

2. The device according to claim 1, wherein
the reception unit is configured to obtain a first position in the obtained first image in accordance with a command,
the product search device further comprises an estimator configured to estimate a determination target region, which to be determined by the determiner, in the first image based on the first position, and
the determiner is configured to determine to which group the item included in the determination target region of the obtained first image belongs.

3. The device according to claim 2, wherein
the retrieval unit is configured to retrieve the second images corresponding to the received group from the storage unit connected to the product search device through a communication line.

4. The device according to claim 3, wherein
the storage unit further stores an identification information of the product so as to be associated with the groups and the second images of the products, and
the second controller is configured to select, based on the identification information corresponding to the retrieved second images, the second image to be displayed on the display unit among the retrieved second images, and display the selected second image on the display unit.

5. The device according to claim 1, wherein
the obtaining unit is configured to further obtain an third image of a subject, and
the second controller is configured to display a fourth image on the display unit, the fourth image being a combination of the obtained third image and the retrieved second image.

6. A product search method, comprising:
obtaining a first image including a plurality of items;
determining to which group each of the items in the obtained first image belongs among a plurality of groups, the groups being groups into which products related to the items are categorized in accordance with a predetermined categorization condition;
displaying the group to which each of the items belongs on a display unit;
receiving, from a user, an input that specifies at least one of the displayed groups;
searching a storage unit, which stores in advance the groups and second images of the products so as to be associated with each other;
extracting the second image corresponding to the specified group; and
displaying the extracted second image on the display unit.

7. A computer program product comprising a computer-readable medium including a computer program that causes a computer to execute:
obtaining a first image including a plurality of items;
determining to which group each of the items in the obtained first image belongs among a plurality of groups, the groups being groups into which products related to the items are categorized in accordance with a predetermined categorization condition;
displaying the group to which each of the items belongs on a display unit;
receiving, from a user, an input that specifies at least one of the displayed groups;
searching a storage unit, which stores in advance the groups and second images of the products so as to be associated with each other;
extracting the second image corresponding to the specified group; and
displaying the extracted second image on the display unit.
